(19) United States
(12) Patent Application Publication
(10) Pub. No.: US 2026/0094548 A1
(43) Pub. Date: Apr. 2, 2026

(54) Display Driver And Display Apparatus

(71) Applicant: SEIKO EPSON CORPORATION, Tokyo (JP)

(72) Inventor: Kazuaki TANAKA, Chino (JP)

(21) Appl. No.: 19/341,127

(22) Filed: Sep. 26, 2025

(30) Foreign Application Priority Data
Sep. 27, 2024 (JP) 2024-168295

(51) Int. Cl. G09G 3/00; G09G 3/36

(52) U.S. Cl. CPC G09G 3/006; G09G 3/3648; G09G 2330/12

(57) ABSTRACT

A display driver includes a driver circuit that outputs a drive signal, an output terminal that outputs the drive signal to a display electrode of an electro-optical panel, an input terminal to which a monitor signal is input from the display electrode, and an inspection circuit. The inspection circuit includes a comparison circuit that compares a voltage of the monitor signal with a reference voltage, a determination circuit that determines an abnormality based on an expected value corresponding to a voltage level of the drive signal and a comparison result of the comparison circuit, and a potential setting circuit that pulls down or pulls up a signal line of the monitor signal according to the voltage level of the drive signal.

The present application is based on, and claims priority from JP Application Serial Number 2024-168295, filed September 27, 2024, the disclosure of which is hereby incorporated by reference herein in its entirety.

### BACKGROUND

### Technical Field

The present disclosure relates to a display driver, a display apparatus, and the like.

### RELATED ART

JP-A-2020-106633 discloses a liquid crystal driver including a first segment terminal that outputs a drive signal to a segment electrode and a second segment terminal that inputs a monitor signal from the segment electrode. In JP-A-2020-106633, a detection circuit detects a driving abnormality of the segment electrode based on the monitor signal, thereby detecting an abnormality in a signal line of a liquid crystal panel.

JP-A-2020-106633 is an example of the related art.

However, for example, when a signal line coupling the detection circuit and a display electrode is disconnected, the potential of the monitor signal becomes unstable, and there is a high possibility that the abnormality cannot be correctly detected.

### SUMMARY

An aspect of the present disclosure relates to a display driver including a driver circuit that outputs a drive signal, an output terminal that outputs the drive signal to a display electrode of an electro-optical panel, an input terminal to which a monitor signal is input from the display electrode, and an inspection circuit, wherein the inspection circuit includes a comparison circuit that compares a voltage of the monitor signal with a reference voltage, a determination circuit that determines an abnormality based on an expected value corresponding to a voltage level of the drive signal and a comparison result of the comparison circuit, and a potential setting circuit that pulls down or pulls up a signal line of the monitor signal according to the voltage level of the drive signal.

Another aspect of the present disclosure relates to a display apparatus including the display driver described above and the electro-optical panel.

### BRIEF DESCRIPTION OF THE DRAWINGS

FIG. 1 shows a configuration example of a display apparatus according to an embodiment.

FIG. 2 shows a detailed configuration example of the display apparatus.

FIG. 3 shows an example of arrangement of segment electrodes and wiring of segment signal lines.

FIG. 4 shows an example of arrangement of common electrodes and wiring of common signal lines.

FIG. 5 shows a detailed configuration example of an inspection circuit and a driver circuit.

FIG. 6 shows a detailed configuration example of the inspection circuit and the driver circuit.

FIG. 7 shows a configuration and an operation of a potential setting circuit.

FIG. 8 shows the configuration and the operation of the potential setting circuit.

FIG. 9 shows the configuration and the operation of the potential setting circuit.

FIG. 10 shows another configuration example of the potential setting circuit.

FIG. 11 is a signal waveform diagram showing an operation of the display apparatus of the present embodiment.

### DESCRIPTION OF EMBODIMENTS

The present embodiment will hereinafter be described. The embodiment to be described below does not unduly limit the contents described in the claims. Further, not all configurations described in the embodiment are necessarily essential component elements.

### 1. Display Driver and Display Apparatus

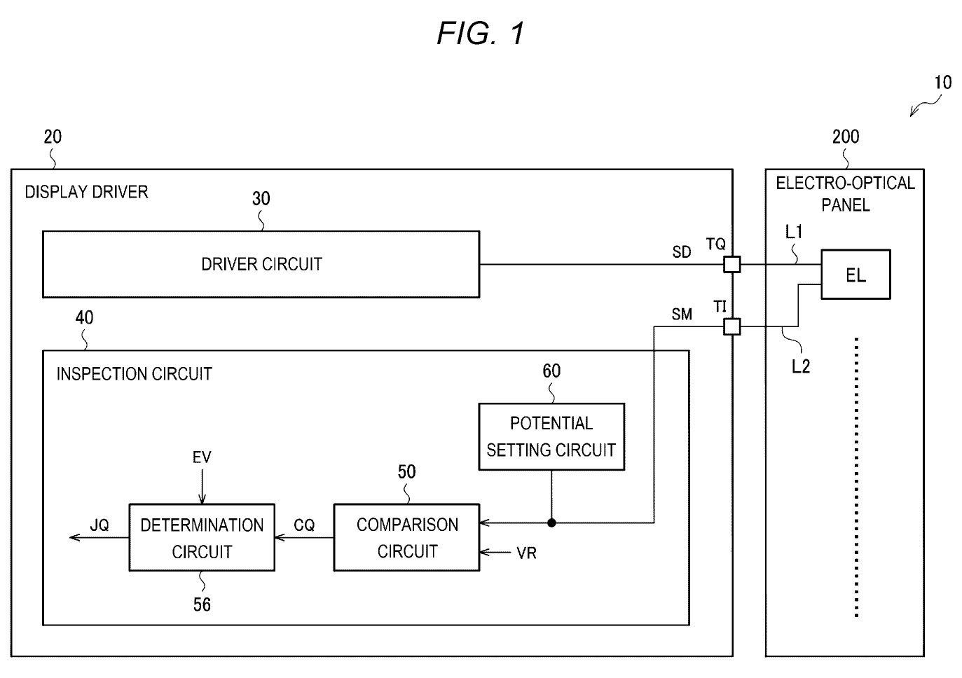

FIG. 1 shows a configuration example of a display apparatus 10 of the present embodiment. The display apparatus 10 includes a display driver 20 and an electro-optical panel 200. The display driver 20 includes a driver circuit 30, an inspection circuit 40, an output terminal TQ, and an input terminal TI. A plurality of display electrodes EL are provided in the electro-optical panel 200. The display driver 20 and the display apparatus 10 are not limited to the configurations in FIG. 1, but various modifications such as omission of part of component elements thereof, addition of other component elements, or replacement of part of the component elements with other component elements can be made.

The display driver 20 is a circuit that performs driving for displaying an image on the electro-optical panel 200, and is implemented by, for example, a circuit device called an IC (integrated circuit). The circuit device is a semiconductor chip manufactured by a semiconductor process, in which circuit elements are formed on a semiconductor substrate. The display driver 20 is mounted on, for example, a glass substrate of the electro-optical panel 200. For example, the display driver 20 is mounted on a glass substrate on which the display electrodes EL are provided. Alternatively, the display driver 20 may be mounted on a circuit substrate, and the circuit substrate and the electro-optical panel 200 may be coupled by a flexible substrate.

The electro-optical panel 200 is a display panel such as a liquid crystal panel. The electro-optical panel 200 includes the plurality of display electrodes EL and a plurality of electro-optical elements. The electro-optical element is, for example, a liquid crystal element. Each pixel of the electro-optical panel 200 is formed with the display electrode EL and the electro-optical element, and an image is displayed on the electro-optical panel 200.

The display apparatus 10 is, for example, an apparatus that displays an image based on image data. The display apparatus 10 is also called a display module or an electro-optical apparatus. The display apparatus 10 is, for example, an in-vehicle display instrument such as a cluster display that is an instrument panel display, a center information display, a head-up display that displays a virtual image in a user's field of view, or an electronic mirror. The in-vehicle display instrument is a display apparatus provided in a motor vehicle such as a four-wheel or two-wheel motor vehicle. Alternatively, the display apparatus 10 may be a display apparatus provided in a vehicle other than a car, such as a ship, a head mounted display apparatus called an HMD, a television apparatus, or a display of an information processing apparatus.

The display driver 20 includes the driver circuit 30, the output terminal TQ, the input terminal TI, and the inspection circuit 40.

The driver circuit 30 outputs a drive signal SD for driving the electro-optical panel 200. When the electro-optical panel 200 is a segment liquid crystal panel, the driver circuit 30 outputs a segment drive signal for driving a segment electrode or a common drive signal for driving a common electrode as the drive signal SD.

The output terminal TQ is a terminal that outputs the drive signal SD to the display electrode EL of the electro-optical panel 200. The input terminal TI is a terminal to which a monitor signal SM is input from the display electrode EL. The input terminal TI can also be called a monitor terminal. The output terminal TQ and the input terminal TI are, for example, pads of the display driver 20 as the circuit device. For example, in a pad region, a metal layer is exposed through a passivation film, which is an insulating layer, and the exposed metal layer forms the pad as the terminal of the display driver 20. The terminals may be external coupling terminals of a package that houses the display driver 20.

The inspection circuit 40 is a circuit for inspecting an abnormal state such as disconnection or short circuit of a signal line or the like of the electro-optical panel 200, and includes a comparison circuit 50, a determination circuit 56, and a potential setting circuit 60.

The comparison circuit 50 compares the voltage of the monitor signal SM with a reference voltage VR. That is, in the electro-optical panel 200, signal lines L1 and L2 having one ends coupled to the display electrodes EL are wired. The drive signal SD from the driver circuit 30 is output to the display electrode EL via the signal line L1, and the monitor signal SM from the display electrode EL is input to the inspection circuit 40 via the signal line L2. The inspection circuit 40 inspects whether an abnormality of the signal line is detected based on the monitor signal SM fed back from the display electrode EL driven by the drive signal SD. Specifically, the comparison circuit 50 of the inspection circuit 40 compares the voltage of the input monitor signal SM with the reference voltage VR and outputs a signal CQ indicating a comparison result, and the determination circuit 56 detects an abnormality based on the comparison result. The reference voltage VR is a threshold voltage for determination, and may be, for example, a voltage that is substantially intermediate between the high-level potential and the low-level potential of the monitor signal SM. In this case, the comparison circuit 50 may compare two or more reference voltages VR with the voltage of the monitor signal SM. For example, the comparison circuit 50 may compare a reference voltage at a high potential side with the voltage of the monitor signal SM, compare a reference voltage at a low potential side with the voltage of the monitor signal SM, and output a comparison result. Note that the coupling in the present embodiment is electrical coupling. The electrical coupling refers to coupling that enables transmission of an electrical signal, and is coupling that enables transmission of information with the electrical signal. The electrical coupling may be coupling through a passive element and the like.

The determination circuit 56 determines an abnormality based on an expected value EV corresponding to the voltage level of the drive signal SD and the comparison result of the comparison circuit 50. For example, the determination circuit 56 determines a driving abnormality that driving of the display electrode EL is abnormal. For example, the determination circuit 56 determines an abnormality of the signal line. Then, the determination circuit 56 outputs a signal JQ indicating a determination result of the abnormality. For example, the determination circuit 56 determines whether an abnormal state such as disconnection or short circuit of the signal lines L1 and L2 has occurred based on the signal of the expected value EV and the signal CQ of the comparison result from the comparison circuit 50, and outputs the signal JQ indicating that such an abnormality has occurred. The expected value EV is a value expected as a voltage level of a signal output as the drive signal SD by the driver circuit 30. For example, the expected value EV is a value at a first logic level when the driver circuit 30 outputs the high-level drive signal SD and at a second logic level when the driver circuit 30 outputs the low-level drive signal SD. In the following description, the first logic level is a high level and the second logic level is a low level. However, the first logic level may be a low level and the second logic level may be a high level. The high level of the drive signal SD of the driver circuit 30 corresponds to, for example, a high level of a drive power supply voltage used for driving the electro-optical panel 200, and the high level of the expected value EV corresponds to, for example, a high level of a logic power supply voltage.

The potential setting circuit 60 sets the potential of the signal line L2 of the monitor signal SM according to the voltage level of the drive signal SD. For example, the potential setting circuit 60 pulls down or pulls up the signal line L2 of the monitor signal SM according to the voltage level of the drive signal SD. For example, the potential setting circuit 60 pulls down or pulls up the signal line L2 of the monitor signal SM according to whether the drive signal SD is at the high level or the low level. The signal line L2 is a signal line having one end coupled to the display electrode EL to which the drive signal SD of the driver circuit 30 is input, and is a signal line to which the monitor signal SM at a voltage level corresponding to the drive signal SD is expected to be transmitted. In this case, for example, when an abnormality such as disconnection occurs in the signal line L1 of the drive signal SD, the monitor signal SM at the voltage level corresponding to the drive signal SD is not transmitted to the signal line L2, the potential of the signal line L2 becomes unstable, and a situation in which the determination circuit 56 cannot correctly detect the abnormality may occur. In this regard, in the present embodiment, the potential setting circuit 60 sets the potential of the signal line L2 of the monitor signal SM according to the voltage level of the drive signal SD, and pulls down or pulls up the signal line L2, for example. Thus, the occurrence of the situation in which the potential of the signal line L2 becomes unstable and the determination circuit 56 cannot correctly detect an abnormality may be prevented.

As described above, the display driver 20 of the present embodiment includes the driver circuit 30, the output terminal TQ that outputs the drive signal SD from the driver circuit 30 to the display electrode EL, the input terminal TI to which the monitor signal SM is input from the display electrode EL, and the inspection circuit 40. The comparison circuit 50 of the inspection circuit 40 compares the voltage of the monitor signal SM with the reference voltage VR, and the determination circuit 56 determines an abnormality such as disconnection based on the expected value EV corresponding to the voltage level of the drive signal SD and the comparison result of the comparison circuit 50. The potential setting circuit 60 pulls down or pulls up the signal line L2 of the monitor signal SM according to the voltage level of the drive signal SD. Therefore, for example, even when an abnormality such as disconnection of the signal line L1 occurs and the potential of the signal line L2 may become unstable, the potential of the signal line L2 is set to the low level or the high level by the potential setting circuit 60 pulling down or pulling up the signal line L2 of the monitor signal SM according to the voltage level of the drive signal SD. Accordingly, the situation in which the abnormality cannot be correctly detected in the determination circuit 56 may be prevented.

Specifically, the potential setting circuit 60 pulls down the signal line L2 of the monitor signal SM when the drive signal SD output by the driver circuit 30 is at the high level, and pulls up the signal line L2 of the monitor signal SM when the drive signal SD is at the low level. For example, when an abnormality such as disconnection of the signal line L1 of the drive signal SD occurs, the signal line L2 of the monitor signal SM is not driven by the driver circuit 30, and thus the signal line L2 is in a high impedance state and the potential of the monitor signal SM becomes unstable. Therefore, the potential of the monitor signal SM is adversely affected by coupling of the parasitic inter-wiring capacitance or the like due to the potential of the surrounding wiring.

For example, it is assumed that a display electrode ELB in the vicinity of the display electrode EL is driven by a drive signal SDB via a signal line LB. In this case, the signal waveform of the drive signal SDB of the display electrode ELB may be the same as the signal waveform of the drive signal SD of the display electrode EL. For example, when both the display electrode EL and the display electrode ELB are turned on, or when both the display electrode EL and the display electrode ELB are turned off, the drive signal SD and the drive signal SDB have the same signal waveform. Further, it is assumed that the signal line LB of the drive signal SDB is wired in the vicinity of the signal line L2 of the monitor signal SM of the drive signal SD. Then, the monitor signal SM whose potential is unstable due to disconnection or the like is affected by the drive signal SDB of the signal line LB in the vicinity and changes in potential in the same manner as the potential change of the drive signal SDB. For example, due to coupling of the inter-wiring capacitance between the signal line L2 and the signal line LB, when the drive signal SDB is at a high level, the monitor signal SM is also at the high level, and when the drive signal SDB is a low level, the monitor signal SM is also at the low level. As a result, a situation in which, even when an abnormality such as disconnection occurs in the signal line L1 of the drive signal SD, the inspection circuit 40 cannot correctly detect the abnormality may occur.

That is, when an abnormality such as disconnection does not occur, the inspection circuit 40 determines that the comparison result of the comparison circuit 50 matches the expected value and determines that an abnormality does not occur when the monitor signal SM is at the high level when the drive signal SD is at the high level and the monitor signal SM is at the low level when the drive signal SD is at the low level. However, the monitor signal SM whose potential is unstable due to disconnection or the like is affected by the drive signal SDB of the signal line LB in the vicinity of the signal line L2. For example, when the drive signal SDB is at the high level, the drive signal SD is at the high level, and then, the monitor signal SM in the high impedance state is also at the high level due to coupling of parasitic inter-wiring capacitance between the signal line LB and the signal line L2. Or, when the drive signal SD is at the low level, the drive signal SDB is also at the low level and then, the monitor signal SM in the high impedance state also is also at the low level due to the coupling of the parasitic inter-wiring capacitance between the signal line LB and the signal line L2. Therefore, since it is determined that the monitor signal SM changes similarly to the expected value even though an abnormality such as disconnection has occurred, a situation in which the inspection circuit 40 cannot correctly detect the abnormality occurs.

In this regard, in the present embodiment, the potential setting circuit 60 pulls down the signal line L2 of the monitor signal SM when the drive signal SD is at the high level, and pulls up the signal line L2 of the monitor signal SM when the drive signal SD is at the low level. Therefore, when both the drive signal SD and the drive signal SDB in the vicinity are at the high level, the potential setting circuit 60 pulls down the signal line L2, the potential of the monitor signal SM can be prevented from being pulled to the high-level side due to the coupling of the inter-wiring capacitance. Further, when both the drive signal SD and the drive signal SDB in the vicinity are at the low level, the potential setting circuit 60 pulls up the signal line L2, so that the potential of the monitor signal SM can be prevented from being pulled to the low-level side due to the coupling of the inter-wiring capacitance. Therefore, the situation in which the inspection circuit 40 cannot correctly detect an abnormality such as disconnection can be prevented.

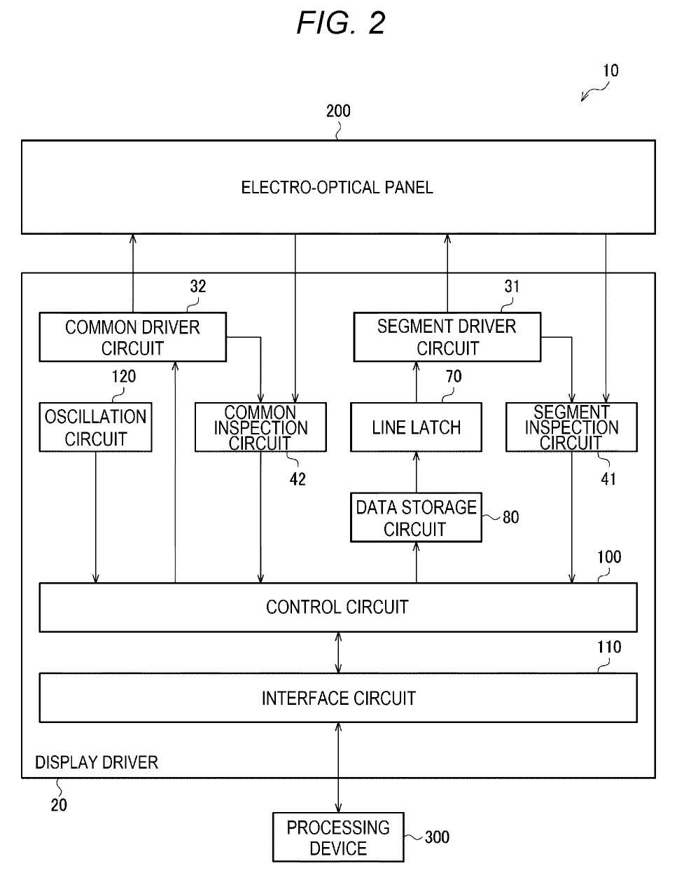

FIG. 2 shows a detailed configuration example of the display driver 20 and the display apparatus 10 of the present embodiment. In FIG. 2, the display apparatus 10 includes the display driver 20, the electro-optical panel 200, and a processing device 300. The display driver 20 and the display apparatus 10 are not limited to the configurations in FIG. 2, but various modifications such as omission of part of component elements thereof, addition of other component elements, or replacement of part of the component elements with other component elements can be made.

The electro-optical panel 200 is, for example, a panel driven by a static driving method. Specifically, the electro-optical panel 200 includes a first glass substrate, a second glass substrate, and liquid crystal. The liquid crystal as an electro-optical element is sealed between the first glass substrate and the second glass substrate. The segment electrodes are provided on the first glass substrate, and common electrodes are provided on the second glass substrate. The display driver 20 outputs a segment drive signal to the segment electrode. The display driver 20 outputs a common drive signal to the common electrode. Accordingly, a drive signal as a potential difference between the segment drive signal and the common drive signal is applied to the liquid crystal between the segment electrode and the common electrode. The segment electrodes and the common electrodes are transparent electrodes, and are made, for example, of ITO (indium tin oxide). Hereinafter, a case where the electro-optical panel 200 is a segment liquid crystal panel having a segment electrode and a common electrode as the display electrode EL will be mainly described as an example, but the present embodiment is not limited thereto.

The processing device 300 is, for example, a host device for the display driver 20, and is implemented by, for example, a processor or a display controller. The processor is, for example, a CPU or a microcomputer. The processing device 300 may be a circuit device implemented by a plurality of circuit components. For example, the processing device 300 may be an ECU (electronic control unit) in an in-vehicle electronic instrument.

The display driver 20 includes a segment driver circuit 31, a common driver circuit 32, a segment inspection circuit 41, a common inspection circuit 42, a line latch 70, a data storage circuit 80, a control circuit 100, an interface circuit 110, and an oscillation circuit 120. Each of the segment driver circuit 31 and the common driver circuit 32 corresponds to the driver circuit 30 in FIG. 1, and each of the segment inspection circuit 41 and the common inspection circuit 42 corresponds to the inspection circuit 40 in FIG. 1. That is, in this case, the display driver 20 includes a plurality of the inspection circuits 40.

The segment driver circuit 31 outputs a segment drive signal to drive the segment electrode of the electro-optical panel 200. For example, the segment driver circuit 31 drives the electro-optical panel 200 by a static driving method, a duty driving method, or the like. For example, the display driver 20 includes an output terminal from which a segment drive signal is output, and the segment drive signal is output to the segment electrode of the electro-optical panel 200 via the output terminal. In this case, the drive signal SD, the display electrode EL, and the output terminal TQ in FIG. 1 correspond to the segment drive signal, the segment electrode, and the output terminal of the segment drive signal, respectively.

The common driver circuit 32 outputs a common drive signal to drive the common electrode of the electro-optical panel 200. For example, the display driver 20 includes an output terminal from which a common drive signal is output, and the common drive signal is output to the common electrode of the electro-optical panel 200 via the output terminal. In this case, the drive signal SD, the display electrode EL, and the output terminal TQ in FIG. 1 correspond to the common drive signal, the common electrode, and the output terminal of the common drive signal, respectively. That is, in this case, the display driver 20 has a plurality of the output terminals TQ.

The segment inspection circuit 41 is a circuit that inspects an abnormality of a signal line or the like of the segment electrode. For example, the segment inspection circuit 41 inspects whether an abnormality such as disconnection or short circuit has occurred in the signal line or the like of the segment electrode. The common inspection circuit 42 is a circuit that inspects an abnormality of a signal line or the like of the common electrode. For example, the common inspection circuit 42 inspects whether an abnormality such as disconnection or short circuit has occurred in the signal line or the like of the common electrode. Each of the segment inspection circuit 41 and the common inspection circuit 42 corresponds to the inspection circuit 40 in FIG. 1. That is, in this case, the display driver 20 includes a plurality of the inspection circuits 40.

The data storage circuit 80 is a circuit that stores display data and the like, and can be implemented by a memory such as a RAM. The data storage circuit 80 stores display data for the electro-optical panel 200. The display data is, for example, on/off data or gradation data for display of a displayed object corresponding to the segment electrode. The display data is received, for example, from the processing device 300 via the interface circuit 110 and stored in the data storage circuit 80.

The line latch 70 latches the display data from the data storage circuit 80. The line latch 70, which is a data latch, latches the display data from the data storage circuit 80 based on, for example, a latch signal from the control circuit 100. The segment driver circuit 31 generates and outputs a segment drive signal based on the data latched by the line latch 70. The line latch 70 is implemented by a flip-flop circuit or the like.

The control circuit 100 is, for example, a logic circuit that operates based on a clock signal from the oscillation circuit 120. The control circuit 100 can be implemented by, for example, an ASIC (application specific integrated circuit) circuit by automatic placement and routing such as a gate array, or a processor such as a CPU. The control circuit 100 performs control of display timing, operation settings of the display driver 20, and the like.

The interface circuit 110 is a circuit that serves as an interface with the external processing device 300, and performs communication processing between the processing device 300 and the display driver 20. For example, the interface circuit 110 receives various data including command data and the display data from the processing device 300. The interface circuit 110 can be implemented by, for example, a serial interface circuit based on the I2C (inter integrated circuit) protocol, the SPI (serial peripheral interface) protocol, or the like.

The oscillation circuit 120 generates an oscillation signal and outputs a clock signal based on the oscillation signal. Each circuit of the display driver 20 such as the control circuit 100 operates based on the clock signal.

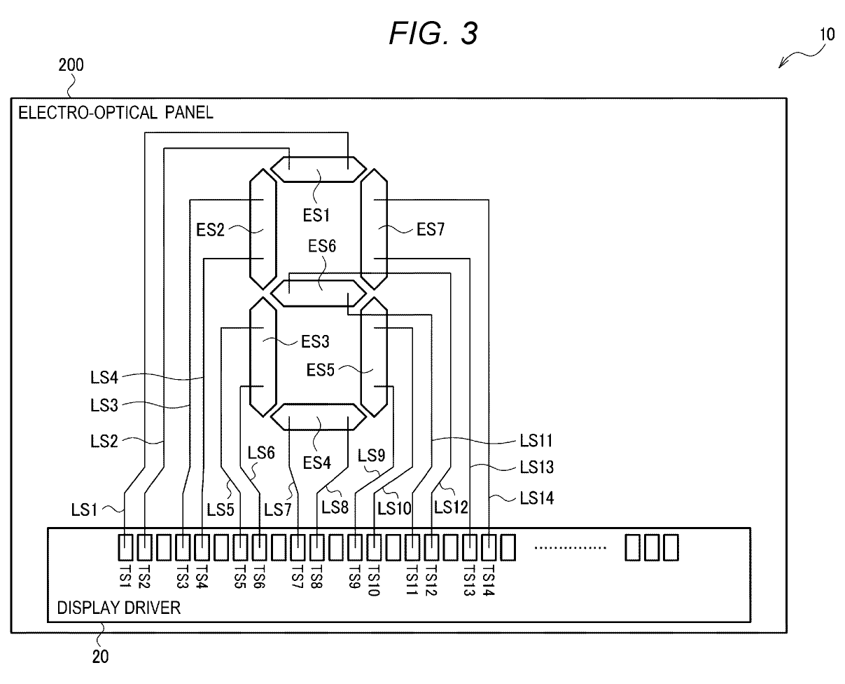

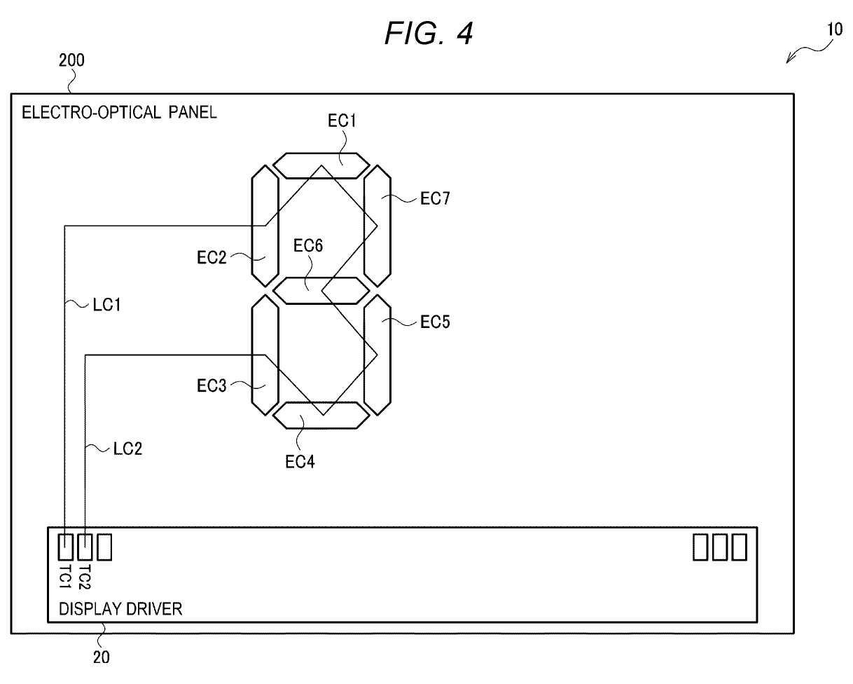

FIG. 3 shows an example of arrangement of segment electrodes and wiring of segment signal lines of the electro-optical panel 200, and FIG. 4 shows an example of arrangement of common electrodes and wiring of common signal lines.

In FIG. 3, segment electrodes ES1 to ES7 and segment signal lines LS1 to LS14 are provided in the electro-optical panel 200. Further, segment terminals TS1 and TS2 of the display driver 20 are coupled to the segment electrode ES1 by the segment signal lines LS1 and LS2, respectively. The segment terminals TS3 and TS4 of the display driver 20 are coupled to the segment electrode ES2 by the segment signal lines LS3 and LS4, respectively. The same applies to the coupling between the segment terminals TS5 to TS14 and the segment electrodes ES3 to ES7 by the segment signal lines LS5 to LS14. Each of the segment terminals TS1, TS3, TS5, TS7, TS9, TS11, and TS13 in FIG. 3 corresponds to the output terminal TQ from which the drive signal SD is output in FIG. 1. Each of the segment terminals TS2, TS4, TS6, TS8, TS10, TS12, and TS14 corresponds to the input terminal TI to which the monitor signal SM is input. Although FIG. 3 shows an example in which the segment electrode is an electrode for 7-segment display, the segment electrode includes electrodes in various forms such as an icon electrode of a warning lamp.

In FIG. 4, the electro-optical panel 200 is provided with common electrodes EC1 to EC7 and common signal lines LC1 and LC2. Further, common terminals TC1 and TC2 of the display driver 20 are coupled to the common electrodes EC1 to EC7 by the common signal lines LC1 and LC2, respectively. The common terminal TC1 in FIG. 4 corresponds to the output terminal TQ from which the drive signal SD is output in FIG. 1. The common terminal TC2 corresponds to the input terminal TI to which the monitor signal SM is input.

### 2. Inspection Circuit and Driver Circuit

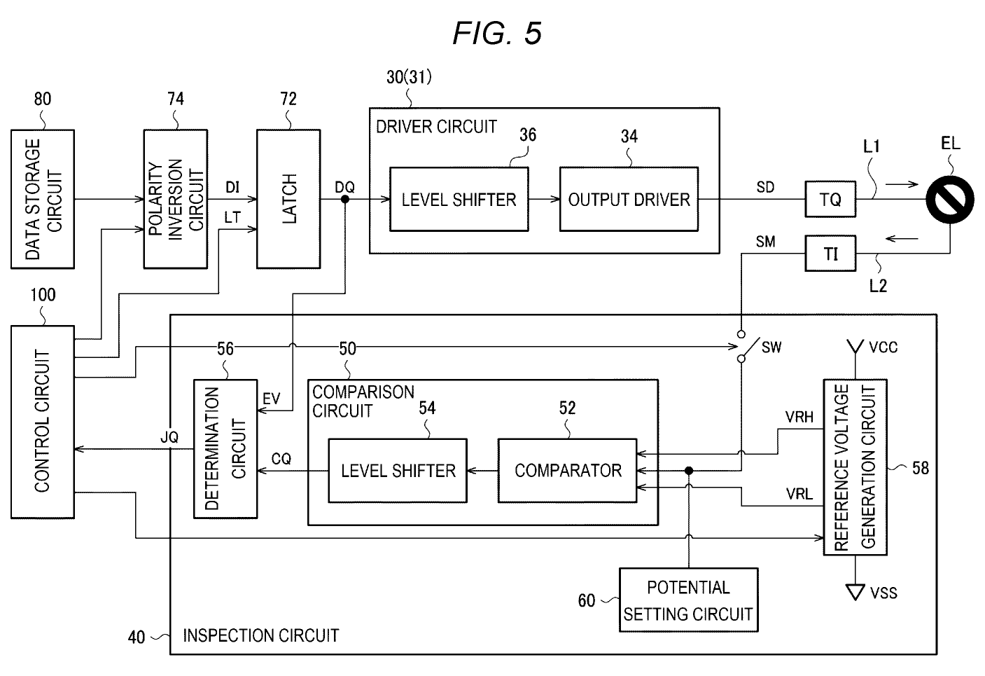

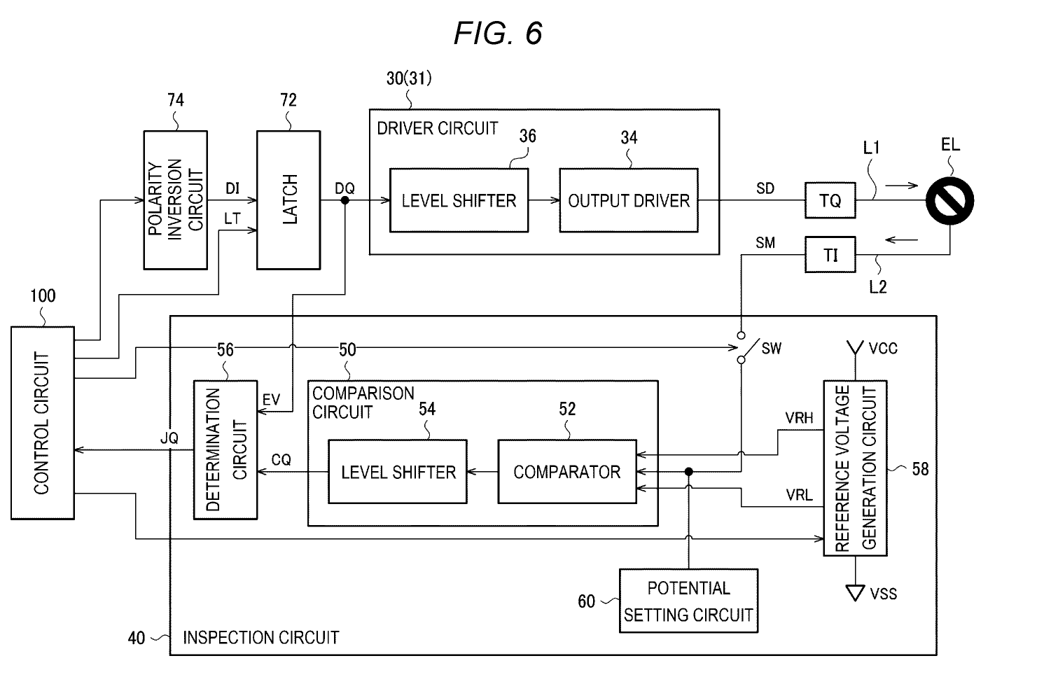

FIGS. 5 and 6 show detailed configuration examples of the inspection circuit 40 and the driver circuit 30. FIG. 5 shows a configuration example in which the inspection circuit 40 and the driver circuit 30 are the segment inspection circuit 41 and the segment driver circuit 31 in FIG. 2, respectively. FIG. 6 shows a configuration example in which the inspection circuit 40 and the driver circuit 30 are the common inspection circuit 42 and the common driver circuit 32 in FIG. 2, respectively. Accordingly, in FIG. 5, the driver circuit 30 outputs a segment drive signal SD based on the display data from the data storage circuit 80. In contrast, in FIG. 6, the display data is not input, and the driver circuit 30 outputs a common drive signal SD under the control of the control circuit 100. Hereinafter, for simplification of description, the configuration in FIG. 5 will be mainly described as an example.

A polarity inversion circuit 74 performs polarity inversion processing of the segment display data read from the data storage circuit 80 based on a polarity signal input from the control circuit 100. For example, the polarity inversion circuit 74 outputs data DI at the same logic level as the display data in a positive polarity frame, and outputs data DI obtained by inverting the logic level of the display data in a negative polarity frame. The latch 72 latches the data DI from the polarity inversion circuit 74 based on the latch signal LT from the control circuit 100. The latch 72 is a latch forming the line latch 70 in FIG. 2, and is implemented by, for example, a flip-flop circuit.

The driver circuit 30 includes a level shifter 36 and an output driver 34. The level shifter 36 receives latched data DQ from the latch 72 and shifts the level of the signal of the data DQ. For example, the level shifter 36 performs level shift for converting a logic power supply voltage level into a drive power supply voltage level of the electro-optical panel 200. Then, the output driver 34 outputs the drive signal SD based on the display signal after the level shift by the level shifter 36.

The inspection circuit 40 includes the comparison circuit 50, the determination circuit 56, a reference voltage generation circuit 58, the potential setting circuit 60, and a switch SW. The comparison circuit 50 includes a comparator 52 and a level shifter 54.

The switch SW is turned on when the inspection circuit 40 is in a determination mode for determining a driving abnormality. Accordingly, the monitor signal SM from the display electrode EL is input to the comparator 52 of the comparison circuit 50 via the switch SW that is turned on.

The reference voltage generation circuit 58 generates reference voltages VRH and VRL based on power supply voltages VCC and VSS. VCC is a drive power supply voltage at a high potential side of the electro-optical panel 200, and VSS is a power supply voltage at a low potential side. For example, the reference voltage generation circuit 58 includes a ladder resistor circuit having a plurality of resistors coupled in series to a VCC node and a VSS node, and generates the reference voltages VRH and VRL by voltage division by the plurality of resistors. The reference voltage VRH is a reference voltage at a high potential side as the VCC side, and the reference voltage VRL is a reference voltage at a low potential side as the VSS side. The reference voltage VRH is, for example, a voltage of about 60% to 90% of VCC, and the reference voltage VRL is, for example, a voltage of about 10% to 40% of VCC. For example, the reference voltage VRH is a voltage of about 70% of VCC, and the reference voltage VRL is a voltage of about 30% of VCC.

The comparator 52 of the comparison circuit 50 compares the voltage of the monitor signal SM from the display electrode EL with the reference voltages VRH and VRL, and the comparison result is output from the comparison circuit 50 as the signal CQ via the level shifter 54. The level shifter 54 performs level shift for converting the drive power supply voltage level of the electro-optical panel 200 into the logic power supply voltage level. For example, when the voltage of the monitor signal SM is higher than the reference voltage VRH at the high potential side, the comparison circuit 50 outputs the signal CQ at the first logic level as the high level. When the voltage of the monitor signal SM is lower than the reference voltage VRL at the low potential side, the comparison circuit 50 outputs the signal CQ at the second logic level as the low level. The comparison circuit 50 may output the signal CQ indicating an inspection error when the voltage of the monitor signal SM is a voltage between the reference voltage VRH at the high potential side and the reference voltage VRH at the low potential side.

The data DQ from the latch 72 is input to the determination circuit 56 as the expected value EV. For example, when the driver circuit 30 outputs a high-level drive signal SD, a high-level expected value EV is input to the determination circuit 56. When the driver circuit 30 outputs a low-level drive signal SD, a low-level expected value EV is input to the determination circuit 56. Then, the determination circuit 56 compares the expected value EV with the signal CQ of the comparison result from the comparison circuit 50 to determine whether an abnormality has occurred.

For example, the determination circuit 56 determines that no abnormality has occurred when the drive signal SD is at the high level and the expected value EV is at the high level and the voltage of the monitor signal SM is higher than the reference voltage VRH and the signal CQ is at the high level. On the other hand, the determination circuit determines that an abnormality has occurred when the expected value EV is at the high level and the signal CQ is the low-level signal or the signal indicating a detection error.

The determination circuit 56 determines that no abnormality has occurred when the drive signal SD is at the low level and the expected value EV is at the low level and the voltage of the monitor signal SM is lower than the reference voltage VRL and the signal CQ is at the low level. On the other hand, the determination circuit determines that an abnormality has occurred when the expected value EV is at low level and the signal CQ is the high-level signal or the signal indicating a detection error.

In this way, when the driver circuit 30 outputs the high-level drive signal SD to the display electrode EL, the determination circuit 56 can determine that no abnormality has occurred when the voltage of the monitor signal SM from the display electrode EL is a voltage corresponding to the high level. Further, the determination circuit 56 can determine that no abnormality has occurred when the driver circuit 30 outputs the low-level drive signal SD to the display electrode EL and the voltage of the monitor signal SM from the display electrode EL is a voltage corresponding to the low level.

### 3. Potential Setting Circuit

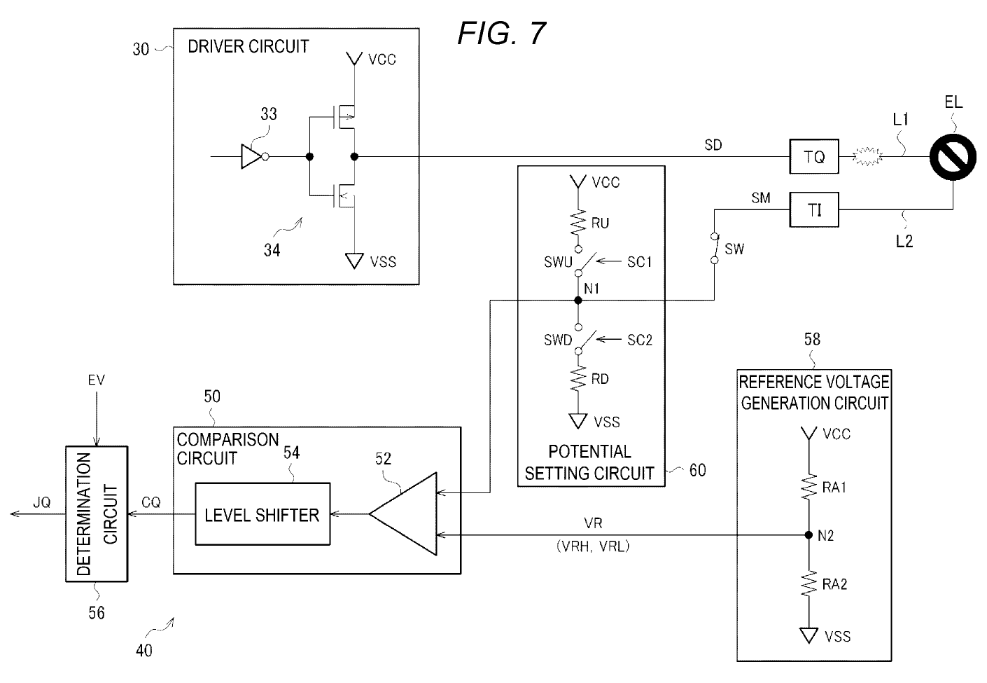

Next, the configuration and the operation of the potential setting circuit 60 of the present embodiment will be described in detail. FIGS. 7, 8, and 9 show the configuration and the operation of the potential setting circuit 60.

In FIG. 7, the potential setting circuit 60 includes a resistor RU and a switch SWU for pull-up, and a resistor RD and a switch SWD for pull-down. The resistor RU and the switch SWU for pull-up are provided in series between the node of the power supply voltage VCC at the high potential side and a node N1 of the signal line L2 of the monitor signal SM. The pull-down resistor RD and switch SWD are provided in series between the node of the power supply voltage VSS at the low potential side and the node N1 of the signal line L2 of the monitor signal SM.

The reference voltage generation circuit 58 includes resistors RA1 and RA2 provided in series between the node of the power supply voltage VCC at the high potential side and the node of the power supply voltage VSS at the low potential side. The reference voltage VR is generated and output to a coupling node N2 between the resistor RA1 and the resistor RA2. Although it is desirable to generate the two reference voltages VRH and VRL at the high potential side and the low potential side as shown in FIGS. 5 and 6 for accurate abnormality detection, a case where one reference voltage VR is used will be mainly described below as an example for simplification of description.

The driver circuit 30 includes a pre-buffer circuit 33 formed using an inverter circuit, and an output driver 34 to which an output signal of the pre-buffer circuit 33 is input and which outputs the drive signal SD.

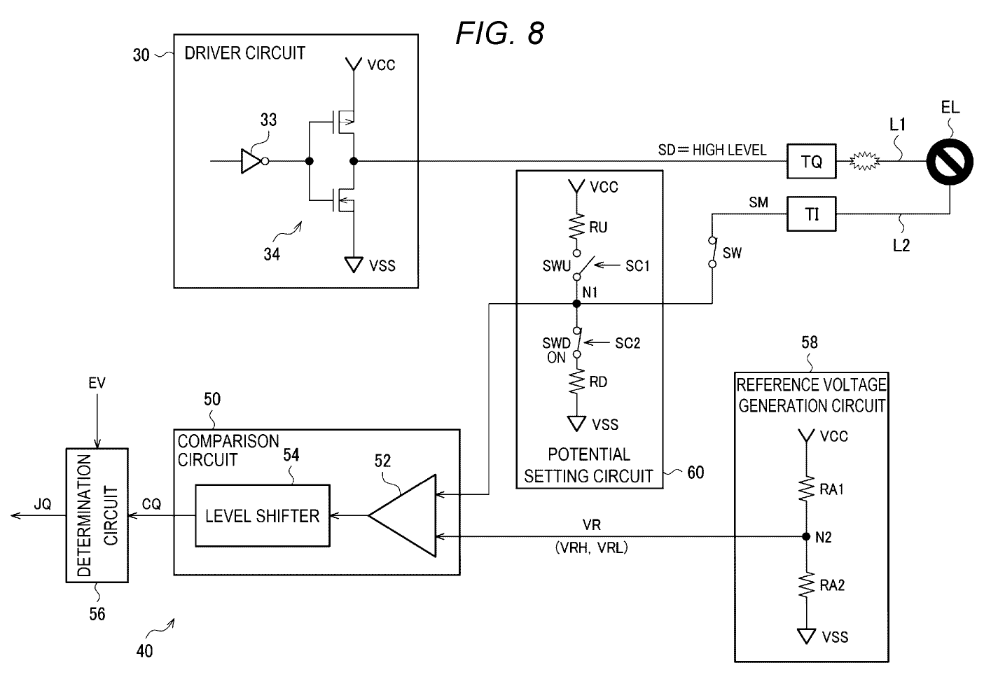

For example, in FIG. 8, the driver circuit 30 outputs the high-level drive signal SD, but disconnection occurs in the signal line L1. Since the signal line L2 of the monitor signal SM is not driven by the driver circuit 30 due to the disconnection, the potential of the monitor signal SM becomes unstable unless the potential setting circuit 60 is provided.

In this regard, in the present embodiment, when the drive signal SD output by the driver circuit 30 is at the high level, the pull-down switch SWD of the potential setting circuit 60 is turned on. The switch SWD is turned on, and thus the signal line L2 of the monitor signal SM is pulled down to the low level by the pull-down resistor RD. When the monitor signal SM pulled down to the low level is input, the comparison circuit 50 outputs the signal CQ indicating the low level as a comparison result because the voltage of the monitor signal SM is lower than the reference voltage VR. On the other hand, when the drive signal SD is at the high level, the expected value EV indicating the high level is input to the determination circuit 56. Accordingly, the level of the signal CQ of the comparison result does not match the expected value EV, and the determination circuit 56 determines that an abnormality has occurred. Therefore, the disconnection of the signal line L1 can be appropriately determined as an abnormality.

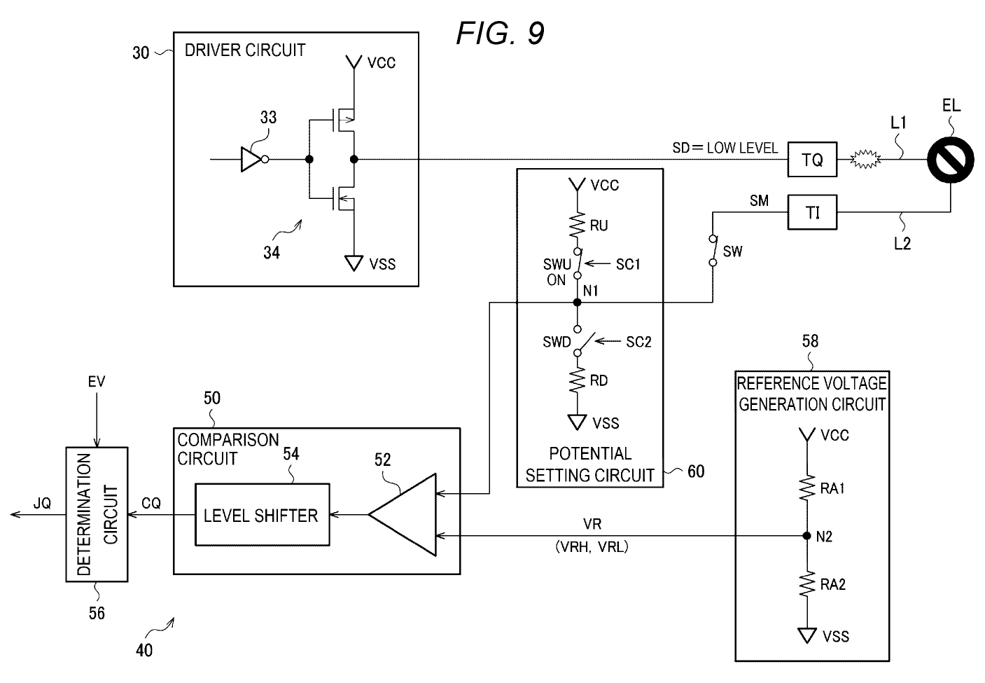

In FIG. 9, the driver circuit 30 outputs the low-level drive signal SD, but disconnection occurs in the signal line L1. Since the signal line L2 of the monitor signal SM is not driven by the driver circuit 30 due to the disconnection, the potential of the monitor signal SM becomes unstable unless the potential setting circuit 60 is provided.

In this regard, in the present embodiment, when the drive signal SD output by the driver circuit 30 is at the low level, the pull-up switch SWU of the potential setting circuit 60 is turned on. The switch SWU is turned on, and thus the signal line L2 of the monitor signal SM is pulled up to the high level by the pull-up resistor RU. When the monitor signal SM pulled up to the high level is input, the comparison circuit 50 outputs the signal CQ indicating the high level as a comparison result because the voltage of the monitor signal SM is higher than the reference voltage VR. On the other hand, when the drive signal SD is at the low level, the expected value EV indicating the low level is input to the determination circuit 56. Accordingly, the level of the signal CQ of the comparison result does not match the expected value EV, and the determination circuit 56 determines that an abnormality has occurred. Therefore, the disconnection of the signal line L1 can be appropriately determined as an abnormality.

As described above, the potential setting circuit 60 includes the pull-up resistor RU and switch SWU provided in series between the node of the power supply voltage VCC at the high potential side and the node N1 of the signal line L2 of the monitor signal SM, and the pull-down resistor RD and switch SWD provided in series between the node of the power supply voltage VSS at the low potential side and the node N1 of the signal line L2 of the monitor signal SM. According to the configuration, for example, the pull-down switch SWD is turned on by a control signal SC2 from the control circuit 100, and thus the signal line L2 of the monitor signal SM can be pulled down by the pull-down resistor RD. The pull-up switch SWU is turned on by a control signal SC1 from the control circuit 100, and thus the signal line L2 of the monitor signal SM can be pulled up by the pull-up resistor RU. Therefore, for example, even when an abnormality such as disconnection of the signal line L1 occurs and the potential of the signal line L2 becomes unstable, the signal line L2 of the monitor signal SM can be pulled down or pulled up by turning on the pull-down switch SWD or the pull-up switch SWU. Accordingly, the situation in which the abnormality cannot be correctly detected in the determination circuit 56 may be prevented.

The pull-down switch SWD is turned on when the drive signal SD is at the high level, and the pull-up switch SWU is turned on when the drive signal SD is at the low level.

According to the configuration, when the drive signal SD of the driver circuit 30 is at the high level, the pull-down switch SWD is turned on, and thus the signal line L2 of the monitor signal SM is pulled down and set at the low level. Accordingly, the comparison circuit 50 outputs a comparison result corresponding to the low level. When the drive signal SD is at the high level, the expected value EV corresponding to the high level is input, and thus the determination circuit 56 can correctly detect that an abnormality has occurred. When the drive signal SD of the driver circuit 30 is at the low level, the pull-up switch SWU is turned on, and thus the signal line L2 of the monitor signal SM is pulled up and set at the high level. Accordingly, the comparison circuit 50 outputs a comparison result corresponding to the high level. When the drive signal SD is at the low level, the expected value EV corresponding to the low level is input, and thus the determination circuit 56 can correctly detect that an abnormality has occurred.

The resistance values of the pull-down resistor RD and the pull-up resistor RU are higher than an on-resistance value of the drive transistor of the driver circuit 30. For example, the drive transistor is a P-type or N-type transistor forming the output driver 34 of the driver circuit 30 in FIGS. 7 to 9. For example, in a normal operation in which no abnormality occurs, when the drive signal SD is at the high level and the pull-down switch SWD is turned on, the drive signal SD is pulled down to the low potential side via the pull-down resistor RD. When the drive signal SD is at the low level and the pull-up switch SWU is turned on, the drive signal SD is pulled up to the high potential side via the pull-up resistor RU. In this case, when the resistance value of the pull-down resistor RD or the pull-up resistor RU is lower than the on-resistance value of the drive transistor of the driver circuit 30, the driving of the display electrode EL by the drive signal SD may be adversely affected. In this regard, in the present embodiment, the resistance values of the pull-down resistor RD and the pull-up resistor RU are higher than the on-resistance value of the drive transistor of the driver circuit 30, and are set to, for example, two to ten times the on-resistance value or more. As an example, the on-resistance value of the drive transistor is, for example, about one kiloohm to several kiloohms, and the resistance values of the resistors RD and RU are, for example, about several tens of kiloohms to several hundreds of kiloohms. According to the configuration, even when the drive signal SD at the high level is pulled down via the pull-down resistor RD or the drive signal SD at the low level is pulled up via the pull-up resistor RU, the adverse effect on the driving of the display electrode EL can be sufficiently reduced.

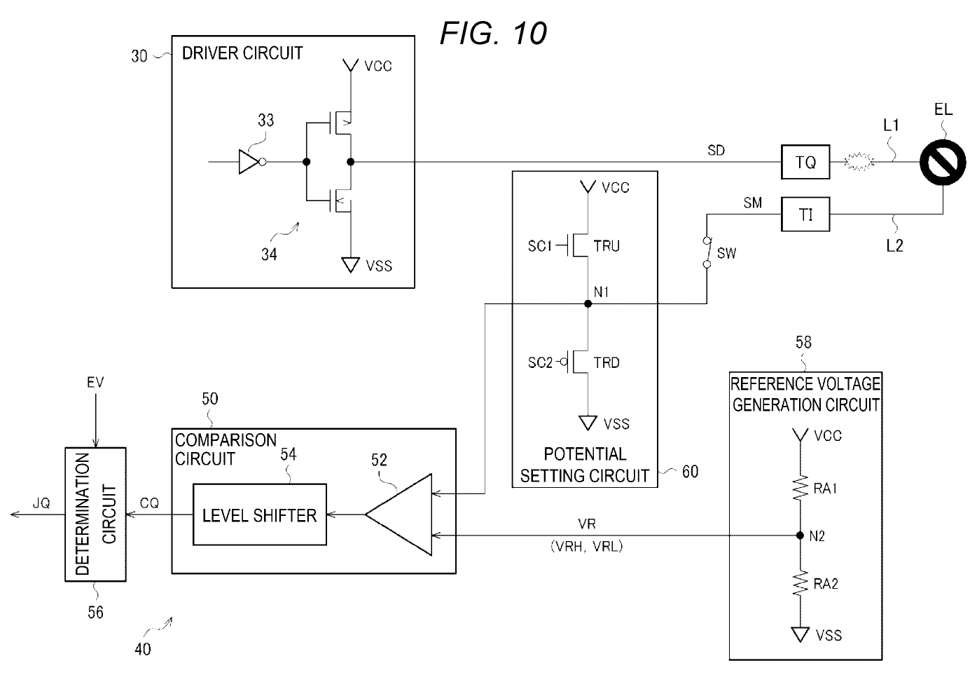

FIG. 10 shows another configuration example of the potential setting circuit 60. In FIG. 10, the potential setting circuit 60 includes a pull-up transistor TRU and a pull-down transistor TRD instead of the pull-up resistor RU and switch SWU and the pull-down resistor RD and switch SWD in FIGS. 7 to 9. Similarly to the resistor RD and the resistor RU, the on-resistance values of the transistor TRU and the transistor TRD are higher than the on-resistance values of the drive transistors of the driver circuit 30. The pull-up transistor TRU is provided between the node of the power supply voltage VCC at the high potential side and the node N1 of the signal line L2 of the monitor signal SM. For example, in the P-type pull-up transistor TRU, the source is coupled to the VCC node, the drain is coupled to the node N1, and the control signal SC1 is input to the gate. The pull-down transistor TRD is provided between the node of the power supply voltage VSS at the low potential side and the node N1 of the signal line L2 of the monitor signal SM. For example, in the N-type pull-down transistor TRD, the source is coupled to the VSS node, the drain is coupled to the node N1, and the control signal SC2 is input to the gate.

When the drive signal SD is at the high level, the pull-down transistor TRD is turned on by the control signal SC2 from the control circuit 100, and the signal line L2 of the monitor signal SM is pulled down. Accordingly, the comparison circuit 50 outputs a signal CQ indicating the low level. When the drive signal SD is at the high level, the expected value EV indicating the high level is input to the determination circuit 56 and does not match the signal CQ indicating the low level, so that it is appropriately determined that an abnormality has occurred.

When the drive signal SD is at the low level, the pull-up transistor TRU is turned on by the control signal SC1 from the control circuit 100, and the signal line L2 of the monitor signal SM is pulled up. Accordingly, the comparison circuit 50 outputs a signal CQ indicating the high level. When the drive signal SD is at the low level, the expected value EV indicating the low level is input to the determination circuit 56 and does not match the signal CQ indicating the high level, so that it is appropriately determined that an abnormality has occurred.

As described above, the potential setting circuit 60 includes the pull-up transistor TRU provided between the node of the power supply voltage VCC at the high potential side and the node N1 of the signal line L2 of the monitor signal SM, and the pull-down transistor TRD provided between the node of the power supply voltage VSS at the low potential side and the node N1 of the signal line L2 of the monitor signal SM.

According to the configuration, for example, when the pull-down transistor TRD is turned on by the control signal SC2 from the control circuit 100, the signal line L2 of the monitor signal SM can be pulled down. The pull-up transistor TRU is turned on by the control signal SC1 from the control circuit 100, and thus the signal line L2 of the monitor signal SM can be pulled up. Therefore, for example, even when an abnormality such as disconnection of the signal line L1 occurs and the potential of the signal line L2 becomes unstable, the signal line L2 of the monitor signal SM can be pulled down or pulled up by turning on the pull-down transistor TRD or the pull-up transistor TRU. Accordingly, the situation in which the abnormality cannot be correctly detected in the determination circuit 56 may be prevented.

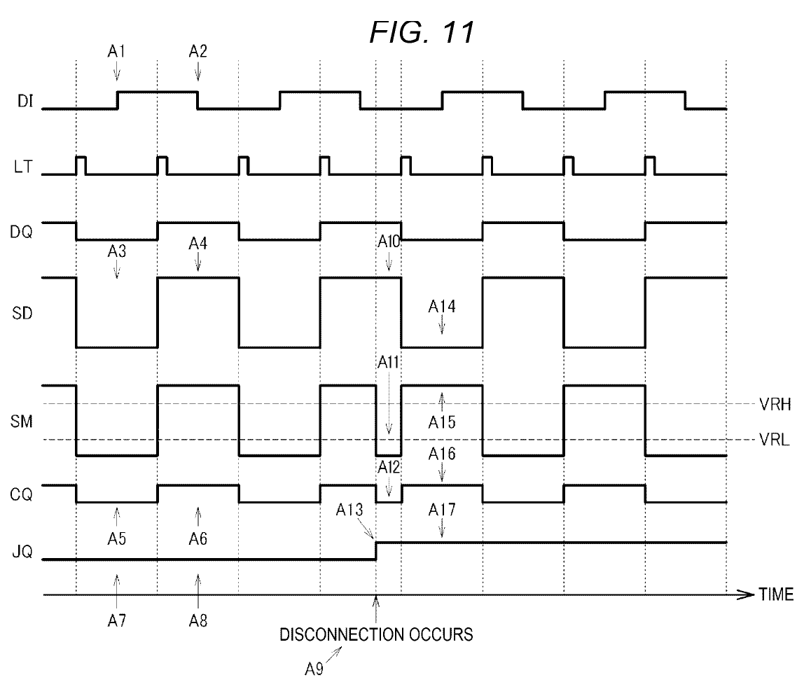

FIG. 11 is a signal waveform diagram showing an operation of the present embodiment. As indicated by A1 and A2 in FIG. 11, the display data DI is latched by the latch 72 in FIG. 5 and output to the driver circuit 30 as the data DQ. Accordingly, as indicated by A3 and A4, the drive signal SD is output to the display electrode EL, and the monitor signal SM corresponding to the drive signal SD is input to the comparison circuit 50 of the inspection circuit 40.

That is, when the drive signal SD is at the low level as indicated by A3, the monitor signal SM is also at the low level, and when the drive signal SD is at the high level as indicated by A4, the monitor signal SM is also at the high level. When the drive signal SD is at the low level, the switch SWU of the potential setting circuit 60 in FIG. 7 is turned on, and the signal line L2 of the monitor signal SM is pulled up, but since the on-resistance value of the N-type drive transistor of the driver circuit 30 is sufficiently lower than the resistance value of the resistor RU, the low level of the monitor signal SM is maintained. When the drive signal SD is at the high level, the switch SWD of the potential setting circuit 60 is turned on and the signal line L2 of the monitor signal SM is pulled down, but since the on-resistance value of the P-type drive transistor of the driver circuit 30 is sufficiently lower than the resistance value of the resistor RD, the high level of the monitor signal SM is maintained.

In A5, since the voltage of the monitor signal SM is lower than the reference voltage VRL (or VR), the signal CQ output by the comparison circuit 50 is at the low level. In A6, since the voltage of the monitor signal SM is higher than the reference voltage VRH (or VR), the signal CQ is at the high level. In the cases of A5 and A6, since the voltage level of the expected value EV corresponding to DQ matches the voltage level of the signal CQ, the signal JQ of the determination result of the determination circuit 56 is at a voltage level (for example, a low level) indicating that no abnormality has occurred, as indicated by A7 and A8.

In A9 of FIG. 11, disconnection of the signal line L1 or the like occurs. When the disconnection occurs, the signal line L2 of the monitor signal SM is not driven by the driver circuit 30, and thus the signal line L2 is in a high impedance state. When the signal line in the vicinity of the signal line L2 is driven by the drive signal similar to the drive signal SD, the drive signal of the signal line in the vicinity is at the high level and the monitor signal SM is also at the high level due to the coupling of the inter-wiring capacitance. When the drive signal of the signal line in the vicinity is at the low level, the monitor signal SM is also at the low level due to the coupling of the inter-wiring capacitance. As a result, the determination circuit 56 may determine that no abnormality has occurred, assuming that the voltage level of the monitor signal SM matches the expected value EV.

In this regard, in the present embodiment, when the drive signal SD is at the high level as indicated by A10, the switch SWD in FIG. 7 is turned on, and the signal line L2 in the high impedance state is pulled down. Accordingly, the voltage of the monitor signal SM is at the low level as indicated by A11, and the signal CQ of the comparison result of the comparison circuit 50 is also at the low level as indicated by A12. Therefore, since the high level as the voltage level of the expected value EV of the drive signal SD and the low level as the voltage level of the signal CQ do not match each other, the signal JQ of the determination result of the determination circuit 56 is at a voltage level (for example, a high level) indicating that an abnormality has occurred as indicated by A13.

Similarly, when the drive signal SD is at the low level as indicated by A14, the switch SWU in FIG. 7 is turned on, and the signal line L2 in the high impedance state is pulled up. Accordingly, the voltage of the monitor signal SM is at the high level as indicated by A15, and the signal CQ of the comparison circuit 50 is also at the high level as indicated by A16. Therefore, since the low level as the voltage level of the expected value EV of the drive signal SD and the high level as the voltage level of the signal CQ do not match each other, the signal JQ of the determination result of the determination circuit 56 is at a voltage level indicating that an abnormality has occurred as indicated by A17.

As described above, in the present embodiment, when the comparison result of the comparison circuit 50 is not the comparison result corresponding to the expected value EV, the determination circuit 56 determines that the disconnection of the signal line L1 of the drive signal SD has occurred. For example, in A12 and A13 of FIG. 11, since the low level as the voltage level of the signal CQ which is the comparison result of the comparison circuit 50 does not match the high level as the voltage level of the expected value EV of the drive signal SD, the determination circuit 56 determines that an abnormality such as disconnection has occurred. In A16 and A17, since the high level as the voltage level of the signal CQ of the comparison circuit 50 does not match the low level as the voltage level of the expected value EV of the drive signal SD, the determination circuit 56 determines that an abnormality such as disconnection has occurred. According to the configuration, the determination circuit 56 can determine whether an abnormality such as disconnection of the signal line L1 of the drive signal SD has occurred only by determining whether the comparison result of the comparison circuit 50 matches the expected value EV corresponding to the voltage level of the drive signal SD. In the present embodiment, even when the potential of the signal line L2 becomes unstable due to disconnection of the signal line L1 or the like, the potential setting circuit 60 performs pull-down when the drive signal SD is at the high level, and performs pull-up when the drive signal SD is at the low level. Therefore, a situation in which the determination circuit 56 that determines whether the comparison result of the comparison circuit 50 matches the expected value EV as described above cannot correctly detect the occurrence of disconnection can be prevented.

As described above, the display driver of the present embodiment includes the driver circuit that outputs the drive signal, the output terminal that outputs the drive signal to the display electrode of the electro-optical panel, the input terminal to which the monitor signal is input from the display electrode, and the inspection circuit. The inspection circuit includes the comparison circuit that compares the voltage of the monitor signal with the reference voltage, the determination circuit that determines an abnormality based on the expected value corresponding to the voltage level of the drive signal and the comparison result of the comparison circuit, and the potential setting circuit that pulls down or pulls up the signal line of the monitor signal according to the voltage level of the drive signal.

According to the present embodiment, the comparison circuit of the inspection circuit compares the voltage of the monitor signal with the reference voltage, and the determination circuit determines an abnormality such as disconnection based on the expected value corresponding to the voltage level of the drive signal and the comparison result of the comparison circuit. The potential setting circuit pulls down or pulls up the signal line of the monitor signal according to the voltage level of the drive signal. Therefore, for example, even when an abnormality such as disconnection occurs and the potential of the signal line of the monitor signal becomes unstable, the potential setting circuit pulls down or pulls up the signal line of the monitor signal, so that the situation in which the abnormality cannot be correctly detected in the determination circuit can be prevented.

In the present embodiment, the potential setting circuit may pull down the signal line of the monitor signal when the drive signal is at the high level, and pull up the signal line of the monitor signal when the drive signal is at the low level.

According to the configuration, when the drive signal is at the high level, the potential setting circuit pulls down the signal line of the monitor signal, so that the potential of the monitor signal can be prevented from being pulled to the high-level side due to the coupling of the inter-wiring capacitance or the like. Further, when the drive signal is at the low level, the potential setting circuit pulls up the signal line of the monitor signal, so that the potential of the monitor signal can be prevented from being pulled to the low-level side due to the coupling of the inter-wiring capacitance or the like.

In the present embodiment, the potential setting circuit may include the pull-up resistor and the pull-up switch provided in series between the node of the power supply voltage at the high potential side and the node of the signal line of the monitor signal, and the pull-down resistor and the pull-down switch provided in series between the node of the power supply voltage at the low potential side and the node of the signal line of the monitor signal.

According to the configuration, even when an abnormality such as disconnection occurs and the potential of the signal line of the monitor signal becomes unstable, the pull-down switch or the pull-up switch is turned on, so that the signal line of the monitor signal can be pulled down or pulled up, and the situation in which the abnormality cannot be correctly detected in the determination circuit can be prevented.

In the present embodiment, the pull-down switch may be turned on when the drive signal is at the high level, and the pull-up switch may be turned on when the drive signal is at the low level.

According to the configuration, when the drive signal is at the high level, the pull-down switch is turned on, so that the signal line of the monitor signal is pulled down and set at the low level. Further, when the drive signal is at the low level, the pull-up switch is turned on, so that the signal line of the monitor signal is pulled up and set at the high level.

In the present embodiment, the resistance values of the pull-down resistor and the pull-up resistor may be higher than the on-resistance value of the drive transistor of the driver circuit.

According to the configuration, even when the drive signal at the high level is pulled down by the pull-down resistor or when the drive signal at the low level is pulled up by the pull-up resistor, the adverse effect on the driving of the display electrode can be reduced.

In the present embodiment, the potential setting circuit may include the pull-up transistor provided between the node of the power supply voltage at the high potential side and the node of the signal line of the monitor signal, and the pull-down transistor provided between the node of the power supply voltage at the low potential side and the node of the signal line of the monitor signal.

According to the configuration, even when an abnormality such as disconnection occurs and the potential of the signal line of the monitor signal becomes unstable, the pull-down transistor or the pull-up transistor is turned on, so that the signal line of the monitor signal can be pulled down or pulled up, and the situation in which the abnormality cannot be correctly detected in the determination circuit can be prevented.

In the present embodiment, the determination circuit may determine that the disconnection of the signal line of the drive signal has occurred when the comparison result of the comparison circuit is not the comparison result corresponding to the expected value.

According to the configuration, the determination circuit can determine the occurrence of disconnection only by determining whether the comparison result of the comparison circuit matches the expected value corresponding to the voltage level of the drive signal.

The display apparatus according to the present embodiment includes the display driver described above and the electro-optical panel.

While the embodiment has been described in detail above, a person skilled in the art can readily understand that many modifications can be made without substantially departing from the novel matters and effects of the present disclosure. Therefore, all such modifications are deemed to be included in the scope of the present disclosure. For example, a term described at least once together with a different term having a broader meaning or the same meaning in the specification or the drawings can be replaced with the different term at any part in the specification or the drawings. Further, all combinations of the present embodiment and the modifications are also included in the scope of the present disclosure. The configurations, operations, and the like of the display driver, the display apparatus, and the like are not limited to those described in the present embodiment, and various modifications can be made.

What is claimed is:

1. A display driver comprising:
a driver circuit that outputs a drive signal;
an output terminal that outputs the drive signal to a display electrode of an electro-optical panel;
an input terminal to which a monitor signal is input from the display electrode; and
an inspection circuit, wherein
the inspection circuit includes
a comparison circuit that compares a voltage of the monitor signal with a reference voltage,
a determination circuit that determines an abnormality based on an expected value corresponding to a voltage level of the drive signal and a comparison result of the comparison circuit, and
a potential setting circuit that pulls down or pulls up a signal line of the monitor signal according to the voltage level of the drive signal.

2. The display driver according to claim 1, wherein
the potential setting circuit pulls down the signal line of the monitor signal when the drive signal is at a high level, and pulls up the signal line of the monitor signal when the drive signal is at a low level.

3. The display driver according to claim 2, wherein
the potential setting circuit includes:
a pull-up resistor and a pull-up switch provided in series between a node of a power supply voltage at a high potential side and a node of the signal line of the monitor signal; and
a pull-down resistor and a pull-down switch provided in series between a node of the power supply voltage at a low potential side and the node of the signal line of the monitor signal.

4. The display driver according to claim 3, wherein
the pull-down switch is turned on when the drive signal is at the high level, and the pull-up switch is turned on when the drive signal is at the low level.

5. The display driver according to claim 3, wherein
resistance values of the pull-down resistor and the pull-up resistor are higher than an on-resistance value of a drive transistor of the driver circuit.

6. The display driver according to claim 2, wherein
the potential setting circuit includes:
a pull-up transistor provided between a node of a power supply voltage at a high potential side and a node of the signal line of the monitor signal; and
a pull-down transistor provided between a node of the power supply voltage at a low potential side and the node of the signal line of the monitor signal.

7. The display driver according to claim 1, wherein
the determination circuit determines that disconnection of the signal line of the drive signal has occurred when the comparison result of the comparison circuit is not a comparison result corresponding to the expected value.

8. A display apparatus comprising:
the display driver according to claim 1; and
the electro-optical panel.
